(19) United States
(12) Patent Application Publication
(10) Pub. No.: US 2025/0296218 A1
(43) Pub. Date: Sep. 25, 2025

(54) Auxiliary Handle Device

(71) Applicant: Robert Bosch GmbH, Stuttgart (DE)

(72) Inventor: Luca De Felice, Denkendorf (DE)

(21) Appl. No.: 19/080,363

(22) Filed: Mar. 14, 2025

(30) Foreign Application Priority Data
Mar. 21, 2024 (DE) 10 2024 202 683.2

(51) Int. Cl. B25F 5/02; B24B 23/02

(52) U.S. Cl. CPC B25F 5/026; B24B 23/028

(57) ABSTRACT

An auxiliary handle device for a hand-held power tool includes at least one main fastening body, at least one main handle body, at least one locking unit, and at least one force-applying element. The at least one main fastening body is configured for direct arrangement on the hand-held power tool. The at least one main fastening body has at least one locking contour. The at least one main handle body is mounted rotatably relative to the at least one main fastening body in at least one operating state. The at least one main handle body has at least one handle surface and at least one locking contour configured to correspond to the at least one locking contour of the main fastening body. The locking unit has a locking element configured for releasable rotational fixing of the main handle body relative to the at least one main fastening body.

This application claims priority under 35 U.S.C. § 119 to patent application no. DE 10 2024 202 683.2, filed on Mar. 21, 2024 in Germany, the disclosure of which is incorporated herein by reference in its entirety.

### BACKGROUND

An auxiliary handle device for a hand-held power tool, having at least one main fastening body which is intended for direct arrangement on the hand-held power tool and which has at least one locking contour, having at least one main handle body which is mounted rotatably relative to the main fastening body in at least one operating state, which has at least one handle surface and at least one locking contour which corresponds to the locking contour of the main fastening body, and having at least one locking unit which has at least one locking element, in particular a locking lever, for releasable rotational fixing of the main handle body relative to the main fastening body.

### SUMMARY

The disclosure is based on an auxiliary handle device for a hand-held power tool having at least one main fastening body which is intended for direct arrangement on the hand-held power tool and which has at least one locking contour, having at least one main handle body which is mounted rotatably relative to the main fastening body in at least one operating state and which has at least one handle surface and at least one locking contour which corresponds to the locking contour of the main fastening body, and having at least one locking unit which has at least one locking element, in particular a locking lever, for releasable rotational fixing of the main handle body relative to the main fastening body.

It is proposed that the auxiliary handle device has at least one force-applying element which is intended to apply a force directed from the main handle body in the direction of the main fastening body to the main handle body. Preferably, the force-applying element is intended to bring or hold the locking contour of the main handle body in engagement with the locking contour of the main fastening body. A force of the force-applying element is preferably independent of a locking position of the locking unit. The force-applying element preferably presses the main handle body in the direction of the main fastening body. However, it would also be conceivable for the force-applying element to pull the main handle body in the direction of the main fastening body.

In this context, an “auxiliary handle device” is to be understood in particular as a device which is intended for a detachable connection to a hand-held power tool and which forms at least one auxiliary handle for the hand-held power tool. In particular, the auxiliary handle device can be either optional or obligatory for operating the hand-held power tool. Preferably, the auxiliary handle device is obligatory for at least one operating state of the hand-held power tool. In particular, it would also be conceivable that auxiliary operating modes and/or a higher power can be called up on the hand-held power tool when the auxiliary handle device is attached. Preferably, the auxiliary handle device is designed to be separable and/or adjustable from the hand-held power tool for transport. The auxiliary handle device is formed in particular by an auxiliary handle, especially a bar handle and/or a bow handle. By “hand-held power tool” is meant, in particular, a workpiece-processing machine, preferably a drilling machine, a drilling and/or impact hammer, a saw, a planer, a screwdriver, a milling machine, a grinder, an angle grinder, a gardening tool, and/or a multi-function tool. Preferably, the hand-held power tool is formed by an angle grinder. However, it would also be conceivable to design the hand-held power tool in another way that would appear sensible to a person skilled in the art.

The main fastening body is intended in particular for direct arrangement on the hand-held power tool. Preferably, the main fastening body can be firmly or detachably connected to the hand-held power tool. Preferably, the main fastening body can be detachably connected to the hand-held power tool, in particular to an auxiliary handle interface of the hand-held power tool. Preferably, the main fastening body has an interface unit for a detachable connection of the auxiliary handle device to the hand-held power tool. In this context, an “interface unit” is to be understood in particular as a unit which is intended for a detachable connection of the auxiliary handle device to the hand-held power tool. Preferably, the auxiliary handle device can be mechanically detachably connected to the hand-held power tool via the interface unit. In particular, the interface unit has a mechanical interface element which is intended to interact with a corresponding interface element of the hand-held power tool. Preferably, the mechanical interface element of the interface unit is intended for a connection to interact positively and/or non-positively with the interface element of the hand-held power tool. Preferably, the interface element of the interface unit is formed, for example, by a bolt, in particular a threaded bolt, which can be inserted and/or screwed into a receiver of the interface element. In this context, the term “detachable” is in particular understood to mean “non-destructively separable”. In a particularly preferred exemplary embodiment, the at least one receptacle unit is intended at least partially for a coupling of the handle device and the fastening unit that can be detached without tools.

In particular, the main handle body forms an actual handle body of the auxiliary handle device, which has a handle area that is intended for direct gripping by an operator. Preferably, the handle area is designed to be gripped by an operator with one hand. Preferably, the handle area comprises in particular an at least approximately cylindrical handle surface.

In this context, a “locking contour” is to be understood in particular as a form-fit contour, especially a surface contour, which is intended to interact with a corresponding locking contour to form an anti-rotation lock. Preferably, in a state coupled with the corresponding locking contour, the locking contour is intended in particular to form a positive connection, especially in the circumferential direction, with the corresponding locking contour. Preferably, the locking contour is formed, for example, by a shaft contour, toothed contour or the like arranged on a front side and rotating in the circumferential direction. The locking contour is intended in particular to prevent relative rotation of the components to one another in a state coupled with the corresponding locking contour. Preferably, the locking contour is intended to be brought into contact with another locking contour for locking, such that a locking force can be transmitted via the two locking contours. The term “positive” should be understood in particular to mean that adjacent surfaces of components connected to each other in a positive manner exert a holding force on each other in the normal direction of the surfaces. In particular, the components are in geometrical engagement with one another.

In this context, a “locking unit” is to be understood in particular as a unit which is intended to prevent the main handle body from moving, in particular twisting, during operation and at the same time to enable the main handle body to be moved, in particular twisted, as required. Preferably, the locking unit, in particular the locking element of the locking unit, has a closed position and an open position, wherein the two locking contours are non-detachably engaged with one another in the closed position. Preferably, the two locking contours can be brought out of engagement with each other in the open position. Preferably, the locking element is formed by a locking lever, wherein the locking element is in the closed position or the open position depending on a pivot position.

Furthermore, in this context, a “force-applying element” is to be understood in particular as an element which is intended to exert a directed, in particular constant, force on the handle base body. Preferably, the force-applying element has a support point for this purpose. Preferably, the force-applying element is formed by a spring element. A “spring element” is to be understood in particular as a macroscopic element which has at least one extension which in a normal operating state is elastically variable by at least 10%, in particular by at least 20%, preferably by at least 30% and particularly advantageously by at least 50%, and which in particular generates a counterforce which is dependent on a change in the extension and preferably proportional to the change and which counteracts the change. An “extension” of an element is to be understood in particular to mean a maximum distance between two points of a perpendicular projection of the element onto a plane. The term “macroscopic element” is in particular understood to mean an element having an extension of at least 1 mm, in particular at least 5 mm, and preferably at least 10 mm.

The term “intended” is to be understood in particular as specially programmed, designed and/or equipped. The fact that an object is intended for a specific function should be understood in particular to mean that the object fulfills and/or executes this specific function in at least one application and/or operating state.

The design of the auxiliary handle device according to the disclosure enables, in particular, an advantageously reliable adjustment of the main handle body. Furthermore, unintentional adjustment of the main handle body can be avoided, even when the locking unit is in an open state. Preferably, the main handle body must be pulled axially outwards for adjustment, in particular against the force of the force-applying element.

It is further proposed that the force-applying element is formed by a compression spring. Preferably, the force-applying element is formed by a helical spring, in particular a helical compression spring. However, another design of the force-applying element that would appear sensible to a person skilled in the art would also be conceivable. The force-applying element is preferably arranged between the locking element and the main handle body. In particular, this makes it possible to provide an advantageous force-applying element. In particular, an advantageously easy-to-assemble and inexpensive force-applying element can be provided.

Furthermore, it is proposed that the locking unit has at least one fastening element, in particular a fastening screw, which is firmly connected to the main fastening body, and at least one axle bolt connected directly to the fastening element, which is intended for a rotatable mounting of the locking element. Preferably, the axle bolt has a central axis that extends perpendicular to a central axis of the fastening element. Preferably, the axle bolt has a radial bore through which the fastening element extends in a mounted state. The fastening element preferably has a head, in particular a screw head, particularly preferably a cylinder screw head, with an enlarged diameter compared to a shaft and/or a thread. The axle bolt is preferably located at the head of the fastening element. It is particularly preferable for the axle bolt to have a step in the radial bore on which the head of the fastening element rests. Preferably, the axle bolt is pressed against the head of the fastening element by means of the force-applying element on the fastening element. The axle bolt is intended in particular for direct pivoting of the locking element. Preferably, the locking element has an axle recess in which the axle bolt is rotatably mounted relative to the locking element. Preferably, the locking element is pivotably mounted via the axle bolt. Preferably, the fastening element extends at least partially through the main handle body. In particular, this makes it possible to intend an advantageously designed stopping unit.

It is further proposed that the locking element is mounted rotatably about an axis of rotation, wherein the locking element has an eccentric contour about the axis of rotation. A central axis of the axle bolt preferably forms the axis of rotation for the locking element. The locking element preferably has an axle mount which is designed to grip the axle bolt. The axle mount of the locking element has an eccentric outer contour, in particular one that is eccentric relative to the axis of rotation. In particular, the axle mount has an at least approximately circular outer contour, the center of which is offset from the axis of rotation. Preferably, the outer contour of the axle mount lies at least partially against the main handle body. Preferably, a distance between the main handle body and the head of the fastening element can be changed depending on a rotational position of the axle mount. In particular, this makes it possible to provide an advantageous stopping mechanism. In particular, an advantageously easy-to-operate locking unit can be provided. In particular, it is possible to dispense with a screw for adjustment.

It is further proposed that the force-applying element is supported with a first end on the axle bolt and with a second end on the main handle body. Preferably, the main handle body has a recess, in particular a cylindrical recess, through which the fastening element extends. In particular, a step is formed in the recess, against which the second end of the force-applying element is supported. In particular, the recess has two diameters through which the step is formed. The first end of the force-applying element is preferably supported on a lateral surface of the axle bolt. In particular, this makes it possible to provide an advantageous force-applying element. In particular, an advantageously easy-to-assemble and inexpensive force-applying element can be provided.

It is further proposed that the force-applying element extends coaxially to the fastening element around the fastening element. In particular, the force-applying element has a hollow cylindrical basic shape, with the fastening element extending coaxially through the force-applying element. Preferably, the force-applying element is arranged around a shaft, in particular between a head and a threaded section, of the fastening element. Preferably, the force-applying element and the fastening element also extend coaxially to the recess of the main handle body. In particular, the fastening element extends through the recess in the main handle body. The force-applying element extends in particular from a side of the main handle body facing the main fastening body into the recess of the main handle body. In particular, this makes it possible to provide an advantageous arrangement of the force-applying element. In particular, reliable guidance of the force-applying element can be enabled.

Furthermore, it is proposed that the auxiliary handle device has a fastening bolt which is intended to connect the main fastening body to a hand-held power tool and which has at least one internal thread for a direct connection to the fastening element of the locking unit. Preferably, the fastening bolt is intended to connect the main fastening body to a hand-held power tool via a connection point for auxiliary handles. In particular, the fastening bolt has a threaded section which is intended to be screwed into an internal thread of the hand-held power tool. Preferably, the fastening bolt extends through a recess in the main fastening body, to which the fastening body is secured via a head of the fastening bolt. The internal thread is arranged in a head of the fastening bolt in particular. In particular, the internal thread extends coaxially to the thread cut of the fastening bolt. In particular, this makes an advantageous fastening of the auxiliary handle device possible.

It is also proposed that the main handle body is formed by a bow handle. However, another design of the main handle body that would appear sensible to a person skilled in the art would also be conceivable. Preferably, the main handle body is only fastened on one side. In particular, the main handle body comprises a fastening arm, on which the main handle body can be connected to the main fastening body, a handle bar adjoining the fastening arm at least approximately perpendicular to the fastening arm and an arm extension adjoining the handle bar at least approximately perpendicular to the handle bar. In particular, the arm extension extends parallel to the fastening arm at one end of the handle bar adjacent to the fastening arm. The fastening arm, the handle bar and the arm extension form a bow handle in particular. It would also be conceivable that the arm extension is also rotatably mounted on the hand-held power tool. In this context, “at least approximately” should be understood to mean in particular that a deviation from a specified value is less than 25%, preferably less than 10% and particularly preferably less than 5% of the specified value. In particular, this makes it possible to provide a reliable auxiliary handle device. In particular, an easy-to-grip main handle body can be provided. Reliable gripping can also be made possible. In particular, reliable gripping can be made possible if the hand-held power tool is designed as a concrete grinder.

It is further proposed that the locking contour of the main handle body and the locking contour of the main fastening body are each formed by a serration coupling. The locking contours are formed in particular by corresponding serration couplings. The locking contours can, for example, each be formed by a Hirth serration coupling. However, other serration couplings that would appear sensible to a person skilled in the art are also conceivable. Preferably, the serration couplings each extend in a ring around the fastening element. In particular, the serration couplings are arranged in a plane perpendicular to the fastening element. In particular, this makes an advantageously reliable locking possible. In particular, twisting in a locked state can be reliably prevented.

Furthermore, it is proposed that the locking element is intended to be released to adjust a rotational position of the main handle body and the main handle body is intended to be moved axially away from the main fastening body and rotated against the force of the force-applying element to adjust a rotational position. Preferably, the locking unit, in particular the locking element of the locking unit, has a closed position and an open position, wherein the two locking contours are non-detachably engaged with one another in the closed position. The locking element is preferably released by pivoting and moved from the closed position to the open position. Furthermore, the locking element can be moved from the open position to the closed position by pivoting it back. Preferably, the locking element is pivoted away from the main handle body in the open position and pivoted towards the main handle body in the closed position. Preferably, the two locking contours can be brought out of engagement with each other in the open position, in particular against the force of the force-applying element. It is particularly preferred that the two locking contours cannot be brought out of engagement with each other in the closed position. Preferably, the locking element is formed by a locking lever, wherein the locking element is in the closed position or the open position depending on a pivot position. In particular, this makes an advantageously convenient operation possible. Furthermore, unintentional adjustment of the main handle body can be avoided, even when the locking unit is in an open state. Preferably, the main handle body must be pulled axially outwards for adjustment, in particular against the force of the force-applying element.

Furthermore, the disclosure is based on a hand-held power tool system with a hand-held power tool and with the auxiliary handle device connected to the hand-held power tool.

The auxiliary handle device according to the disclosure should not be limited to the application and embodiment described above. In particular, the auxiliary handle device according to the disclosure can have a number of individual elements, components and units that differs from the number of elements, components and units mentioned herein in order to fulfill a function described herein. Moreover, regarding the ranges of values indicated in this disclosure, values lying within the limits specified hereinabove are also intended to be considered as disclosed and usable as desired.

### BRIEF DESCRIPTION OF THE DRAWINGS

Further advantages follow from the description of the drawings below. An exemplary embodiment of the disclosure is shown in the drawing. The drawings, the description, and the claims contain numerous features in combination. The person skilled in the art will also expediently consider the features individually and combine them into further sensible combinations.

The figures show:

FIG. 1 a hand-held power tool system with a hand-held power tool and with an auxiliary handle device according to the disclosure, which is connected to the hand-held power tool and has a main handle body and a main fastening body, in a schematic representation,

FIG. 2 the auxiliary handle device according to the disclosure with the main handle body, with the main fastening body and with a locking unit in a schematic exploded view,

FIG. 3 a partial section of the auxiliary handle device according to the disclosure with the main handle body, with the main fastening body and with the locking unit in a closed position in a schematic sectional view and

FIG. 4 a partial section of the auxiliary handle device according to the disclosure with the main handle body, with the main fastening body and with the locking unit in an open position in a schematic sectional view.

### DETAILED DESCRIPTION

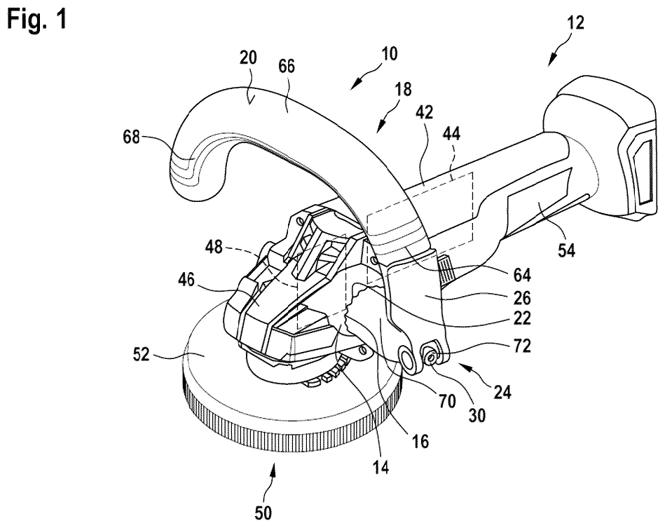

FIG. 1 shows a hand-held power tool system with a hand-held power tool 12 and with an auxiliary handle device 10 connected to the hand-held power tool 12. The hand-held power tool 12 is formed by a concrete grinder. However, another design would also be conceivable to a person skilled in the art, for example as an angle grinder. The hand-held power tool 12 has a drive housing 42 and a drive unit 44 arranged in the drive housing 42. Furthermore, the hand-held power tool 12 has a gearbox housing 46 connected to the drive housing 42, a gearbox 48 arranged in the gearbox housing 46 and a tool interface 50 for connecting an insertion tool to the gearbox 48. Furthermore, the hand-held power tool 12 has a protective cover 52 arranged on the gearbox housing 46. The drive housing 42 has a handle area 54.

The gearbox housing 46 has a recess 56, in particular a threaded recess, for a detachable connection to an auxiliary handle, in particular the auxiliary handle device 10.

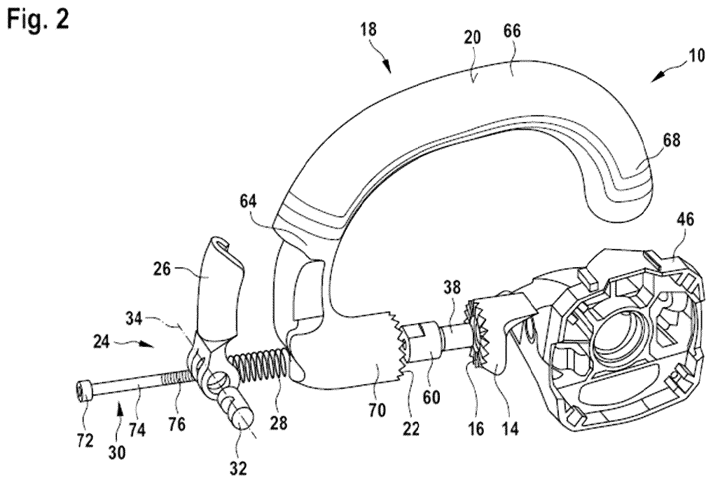

As shown in FIG. 2, the auxiliary handle device 10 has a main fastening body 14, which is intended for direct arrangement on the hand-held power tool 12. The main fastening body 14 is intended for a detachable arrangement on the gearbox housing 46. The main fastening body 14 partially surrounds the gearbox housing 46. The auxiliary handle device 10 also has a fastening bolt 38, which is intended to connect the main fastening body 14 to the hand-held power tool 12. The fastening bolt 38 is intended to connect the main fastening body 14 to the hand-held power tool 12 via a connection point for auxiliary handles. The fastening bolt 38 is intended to connect the main fastening body 14 to the hand-held power tool 12 via the recess 56 of the gearbox housing 46. For this purpose, the fastening bolt 38 has a threaded section 58, which is intended to be screwed into the internal thread of the recess 56 of the gearbox housing 46. The fastening bolt 38 extends through a recess in the main fastening body 14. The fastening bolt 38 has a head 60, via which the main fastening body 14 is secured to the gearbox housing 46. The head 60 is arranged at an end of the fastening bolt 38 facing away from the threaded section 58. Furthermore, the fastening bolt 38 has an internal thread 40. The internal thread 40 is arranged in the head 60 of the fastening bolt 38. The internal thread 40 extends coaxially to the thread cut 58 of the fastening bolt 38.

Furthermore, the auxiliary handle device 10 has a main handle body 18, which is rotatably mounted relative to the main fastening body 14 in at least one operating state and has at least one handle surface 20. The main handle body 18 is formed by a bow handle. The main handle body 18 is only connected to the main fastening body 14 on one side. The main handle body 18 comprises a fastening arm 64, on which the main handle body 18 can be connected to the main fastening body 14, a handle bar 66 adjoining the fastening arm 64 at least approximately perpendicularly to the fastening arm 64, and an arm extension 68 adjoining the handle bar 66 approximately perpendicularly to the handle bar 66. The arm extension 68 extends parallel to the fastening arm 64 at an end of the handle bar 66 applied to the fastening arm 64. The fastening arm 64, the handle bar 66 and the arm extension 68 form a bow handle. The fastening arm 64, the handle bar 66 and the arm extension 68 merge into each other in a rounded shape. The main handle body 18 has a C-shape in particular. The fastening arm 64, the handle bar 66 and the arm extension 68 each have a circular cross-section in particular. An outer surface of the handle bar 66 also forms the handle surface 20.

The main handle body 18 further comprises a cylindrical fastening extension 70 adjoining the fastening arm 64, which extends essentially perpendicular to the fastening arm 64 from the fastening arm 64 in the direction of the main fastening body 14.

The main fastening body 14 has a locking contour 16. Furthermore, the main handle body 18 has a locking contour 22 that corresponds to the locking contour 16 of the main fastening body 14. The locking contour 22 of the main handle body 18 is arranged on one front side of the fastening extension 70. The locking contour 16 of the main fastening body 14 is arranged on a side of the main fastening body 14 facing away from the recess 56 of the gearbox housing 46. The locking contour 22 of the main handle body 18 and the locking contour 16 of the main fastening body 14 are each formed by a serration coupling. The locking contours 16, 22 are formed by corresponding serration couplings. The locking contours 16, 22 can, for example, each be formed by a Hirth serration coupling. However, other serration couplings that would appear sensible to a person skilled in the art are also conceivable. The locking contours 16, 22 are each ring-shaped. In a state coupled with the corresponding locking contour 22, the locking contour 16 is intended to form a positive connection, in particular in the circumferential direction, with the corresponding locking contour 22 and thus to prevent the handle base body 18 from rotating relative to the fastening base body 14.

Furthermore, the auxiliary handle device 10 has a locking unit 24. The locking unit 24 has a locking element 26, which is intended for releasable rotational fixing of the main handle body 18 relative to the main fastening body 14. The locking element 26 is formed by a locking lever. The locking element 26 of the locking unit 24 has a closed position and an open position, with the two locking contours 16, 22 being non-detachably engaged with one another in the closed position. Furthermore, the two locking contours 16, 22 can be disengaged from each other in the open position. The locking element 26 rests against the main handle body 18 in the closed position. The locking element 26 has an actuating lever which, in the closed position, in particular lies flat against the main handle body 18. In particular, the main handle body 18 has a recess in which the locking element 26 is arranged in the closed position. The locking unit 24 also has a fastening element 30, which is firmly connected to the main fastening body 14. The fastening element 30 is formed by a fastening screw. The fastening element 30 has a head 72, which is formed by a cylinder screw head, a shaft 74 and a threaded section 76. The fastening element 30 extends through the main handle body 18. The main handle body 18 has a cylindrical recess which extends through the fastening extension 70, through which the fastening element 30 extends. The fastening element 30 extends through the recess in the main handle body 18. The internal thread 40 of the fastening bolt 38 is intended for a direct connection to the fastening element 30 of the locking unit 24. The threaded section 76 of the fastening element 30 is screwed into the internal thread 40 in an assembled state. Furthermore, the locking unit 24 has an axle bolt 32 directly connected to the fastening element 30, which is intended for a rotatable mounting of the locking element 26. The axle bolt 32 has a central axis which extends perpendicular to a central axis of the fastening element 30. The axle bolt 32 has a radial bore through which the fastening element 30 extends in an assembled state. The axle bolt 32 is in contact with the head 72 of the fastening element 30. The axle bolt 32 has a step in the radial bore, against which the head 72 of the fastening element 30 rests. The axle bolt 32 is pressed against the head 72 of the fastening element 30 by means of a force-applying element 28 on the fastening element 30. The axle bolt 32 is provided for a direct pivot bearing of the locking element 26. The locking element 26 has an axle recess in which the axle bolt 32 is rotatably mounted relative to the locking element 26. The locking element 26 is pivotably mounted via the axle bolt 32.

The locking element 26 is mounted rotatably about an axis of rotation 34, wherein the locking element 26 has an eccentric contour 36 about the axis of rotation 34. A central axis of the axle bolt 32 forms the axis of rotation 34 for the locking element 26. The locking element 26 has an axle mount which is intended to grip around the axle bolt 32. The axle mount of the locking element 26 has an eccentric outer contour, in particular one that is eccentric relative to the axis of rotation 34. The axle mount has an at least approximately circular outer contour, the center of which is offset from the axis of rotation 34. The eccentric contour 36 of the axle mount is partially in contact with the main handle body 18. A distance between the main handle body 18 and the head 72 of the fastening element 30 can be changed depending on a rotational position of the axle mount.

Furthermore, the auxiliary handle device 10 has the force-applying element 28. The force-applying element 28 is intended to apply a force directed from the main handle body 18 in the direction of the main fastening body 14 to the main handle body 18. The force-applying element 28 is formed by a spring element. The force-applying element 28 is formed by a compression spring. The force-applying element 28 is formed by a helical spring. The force-applying element 28 is intended to bring or hold the locking contour 22 of the main handle body 18 into engagement with the locking contour 16 of the main fastening body 14. The force-applying element 28 extends coaxially to the fastening element 30 around the fastening element 30. The force-applying element 28 is supported at a first end on the axle bolt 32 and at a second end on the main handle body 18. A step 78 is formed in the recess of the main handle body 18, through which the fastening element 30 extends, on which the second end of the force-applying element 28 is supported. The recess has two diameters through which the step 78 is formed. The first end of the force-applying element 28 is supported on a lateral surface of the axle bolt 32. The force-applying element 28 has a hollow cylindrical basic shape, with the fastening element 30 extending coaxially through the force-applying element 28. The force-applying element 28 is arranged around the shaft 74 of the fastening element 30. The force-applying element 28 and the fastening element 30 extend coaxially to the recess of the main handle body 18. The force-applying element 28 extends from a side of the main handle body 18 facing the main fastening body 14 into the recess of the main handle body 18.

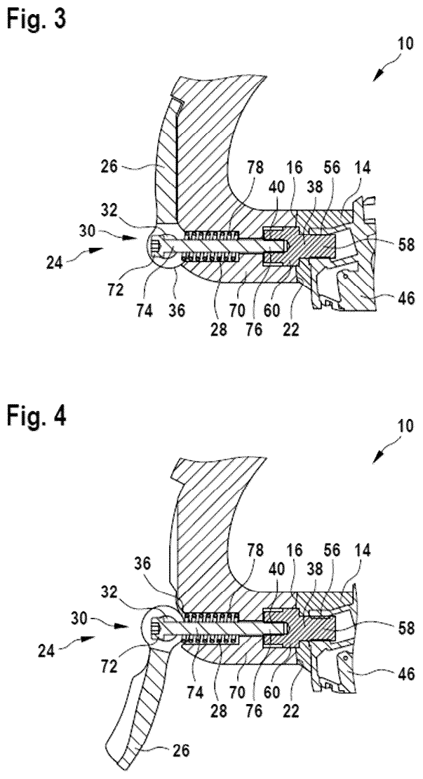

The locking element 26 is intended to be released for an adjustment of a rotational position of the main handle body 18 and the main handle body 18 is intended to be moved axially away from the main fastening body 14 and rotated against the force of the force-applying element 28 for an adjustment of a rotational position. The two locking contours 16, 22 are non-detachably engaged with each other in the closed position (FIG. 3). The locking element 26 is released by pivoting and moved from the closed position to the open position (FIG. 4). Furthermore, the locking element 26 can be moved from the open position to the closed position by pivoting it back. The locking element 26 is pivoted away from the main handle body 18 in the open position and pivoted towards the main handle body 18 in the closed position. The two locking contours 16, 22 can be disengaged from each other in the open position against the force of the force-applying element 28. Furthermore, the two locking contours 16, 22 cannot be brought out of engagement with each other in the closed position.

What is claimed is:

1. An auxiliary handle device for a hand-held power tool, comprising:
at least one main fastening body configured for direct arrangement on the hand-held power tool, the at least one main fastening body having at least one locking contour;
at least one main handle body mounted rotatably relative to the at least one main fastening body in at least one operating state, the at least one main handle body having at least one handle surface and at least one locking contour configured to correspond to the at least one locking contour of the at least one main fastening body;
at least one locking unit having at least one locking element configured for releasable rotational fixing of the at least one main handle body relative to the at least one main fastening body; and
at least one force-applying element configured for applying a force directed from the at least one main handle body in a direction of the at least one main fastening body to the at least one main handle body.

2. The auxiliary handle device according to claim 1, wherein the at least one force-applying element includes a compression spring.

3. The auxiliary handle device according to claim 1, wherein the at least one locking unit has at least one fastening element connected to the at least one main fastening body, and at least one axle bolt directly connected to the at least one fastening element and configured for a rotatable mounting of the at least one locking element.

4. The auxiliary handle device according to claim 1, wherein:
the at least one locking element is mounted rotatably about an axis of rotation, and
the at least one locking element has an eccentric contour about the axis of rotation.

5. The auxiliary handle device according to claim 3, wherein the at least one force-applying element is supported at a first end on the at least one axle bolt and at a second end on the at least one main handle body.

6. The auxiliary handle device according to claim 3, wherein the at least one force-applying element extends coaxially to the at least one fastening element around the at least one fastening element.

7. The auxiliary handle device according to claim 3, further comprising:
a fastening bolt configured to connect the at least one main fastening body to the hand-held power tool, the hand-held power tool having at least one internal thread for a direct connection to the at least one fastening element of the at least one locking unit.

8. The auxiliary handle device according to claim 1, wherein the at least one main handle body includes a bow handle.

9. The auxiliary handle device according to claim 1, wherein the at least one locking contour of the at least one main handle body and the at least one locking contour of the at least one main fastening body are each formed by a serration coupling.

10. The auxiliary handle device according to claim 1, wherein:
the at least one locking element is configured to be released for an adjustment of a rotational position of the at least one main handle body, and
the at least one main handle body is configured to be moved axially away from the at least one main fastening body and rotated for an adjustment of a rotational position counter to the force of the at least one force-applying element.

11. A hand-held power tool system, comprising:
a hand-held power tool, and
the auxiliary handle device according to claim 1, the auxiliary handle device connected to the hand-held power tool.
